(19) United States
(12) Patent Application Publication
(10) Pub. No.: US 2004/0260818 A1
(43) Pub. Date: Dec. 23, 2004

(54) Network security verification system and method

(76) Inventors: Denis Gabriel Valois, Mouans-Sartoux (FR); Cedric Felix Jacques Llorens, Le Chesnay (FR)

Correspondence Address: Elizabeth Stanley, LeBoeuf, Lamb, Greene & MacRae L.L.P., Suite 1200, 1875 Connecticut Avenue, N.W., Washington, DC, 20009, US

(21) Appl. No.: 10/601,290

(22) Filed: Jun. 23, 2003

(51) Int. Cl. G06F 15/16

(52) U.S. Cl. 709/229

(57) ABSTRACT

A system and method for providing compliance verification information in the field of network security, is disclosed. The software system, which is designed to be modular, provides compliance verification information with respect to a security policy. Each level of verification may be performed on a local basis, with respect to a network device, or on a global basis, with respect to multiple network devices, such as a communications network.

### FIELD OF INVENTION

The present invention relates generally to the overall security of network devices. More particularly, the present invention relates to a software system and method that provides configuration compliance verification and/or validation with respect to a security policy.

### BACKGROUND OF INVENTION

Generally, a communications network includes various different types of network devices that allow a personal computer to connect to another computer equipment, such as a host computer. One such network device is a router, which is used to deliver messages between network nodes.

On a single network linking many computers through a mesh of possible connections, a router receives transmitted messages and forwards them to their correct destinations over the most efficient available route.

On an interconnected set of local area networks (LANs), which are generally based on differing architectures and protocols, a router serves an additional function of acting as a link between each local area network, thereby allowing messages to be sent from one LAN to another. In LANs or wide area networks (WANs), routers are used to transfer data packets from a particular station on a LAN to a remote station that is attached to another LAN.

LANs connected by routers do not have to operate at the same speed. The transmitting or local station must know that the destination station is not on the same LAN. The transmitting station sends the message to the router, which acts as a forward message relay system.

Also, the transmitting station only sends specific messages to the router for onward transmission based on control information that the transmitting station first includes in the message. The router uses this control information and its own control and routing tables, to relay the message on to the appropriate LAN. The message may pass through more than one router. Because the router is an intermediate transit system, significant delays may be added to the time taken to transmit messages when routers are used.

The use of different routers in computer networks, a customary practice, structures message delivery. It is not unusual to employ backbone core routers, leased-line edge routers, dial edge routers, customer edge routers and the like, in computer networks today. However, each of these routers uses a different standard configuration template and implements its own security policy, functionalities and services. In a typical large network, which involves several thousands or tens of thousands of routers, configuration management quickly poses a serious problem to network infrastructure.

In troubleshooting message delivery, customer migration or other computer problems, network operators responsible for configuration management oftentimes end up modifying, unknowingly or otherwise, a router's configuration. The unintended consequences of these changes are network security breaches, unstable delivery of network services, and overall network management problems. Current solutions to these problems, particularly network security breaches, are labor intensive, costly and error prone.

### SUMMARY OF INVENTION

The present invention satisfies, to a great extent, the foregoing and other needs not currently satisfied by existing techniques. This result is achieved by a software system and/or method that diagnoses and/or verifies whether a network equipment or a communications network is implementing its intended security policy; and whether a network equipment or a communications network is implementing its intended configuration.

In the context of the present invention, the term, “network equipment” or “network device”, refers to any kind of device used individually or in combination to build or link one or more communication networks. For example, the term includes International Standards Organization/Open Systems Interconnection (ISO/OSI) level-2 network devices, which is the second of the seven layers in the ISO/OSI reference model for standardizing computer-to-computer communications. The data-link layer is one level above the physical layer and ensures the coding, addressing and transmitting of information. An example of an ISO level-2 network device is the Nortel Passport™.

The term “network device” also refers to ISO level-3 (IP) network devices, which is the third of the seven layers in the ISO/OSI reference model for standardizing computer-to-computer communications. The network layer is one level above the data-link layer and ensures that information arrives at its intended destination; it is concerned with the actual movement—transport routes, message handling and transfer—of information from one device to another. Examples of an ISO level-3 network device include Cisco and Juniper routers.

The term “network device” also refers to higher-level communication devices, such as Internet Protocol Security (IPSec) encryption devices.

The term, “configuration”, generally refers to how a device is programmed. It is meant to describe the actual operational behavior of the network device, for example. In this regard, a configuration may be archived in a configuration file.

The term, “security policy”, generally refers to the expected or desired operational behavior of a device. It is meant to describe one or more intended features of a network device, for example, including security features. An interchangeable term is intended functionality.

It is a feature and advantage of the present invention to provide configuration compliance verification information on a network device's security policy.

It is a feature and advantage of the present invention to provide configuration compliance verification information on a communications network's security policy.

It is a feature and advantage of the present invention to provide compliance verification information on the consistency of a network device's access control list(s).

It is yet another feature and advantage of the present invention to generate one or more optimized access control lists (ACLs) from inconsistent ACLs.

It is a feature and advantage of the present invention to provide security policy compliance verification logic in the form of a software module.

It is a feature and advantage of the present invention to provide ACL compliance verification logic in the form of a software module.

It is a feature and advantage of the present invention to provide a software module that is open, flexible and easily modifiable.

In a preferred embodiment, the software system of the present invention comprises five components: a configuration repository database, a test scripts database, a security policy database, a validation engine, and a parser engine. The software system may optionally include a connectivity database.

The first component is a configuration repository database, which includes one or more configuration files. Each configuration file preferably represents information on the arrangement of a network device, substantially describing how a specific network device is programmed. Alternatively and optionally, each configuration file contains information on the arrangement of a communications network.

The second component of the software system is a test scripts database, which contains a number of user-defined tests or expert rules that expresses a desired formulation or inquiry as a test. The test scripts are programs, which may be written in any programming language. Each test script takes as input a network device configuration file and outputs a “pass”/“fail” result, whether on a local or global basis. The test scripts are of varying levels of complexity.

In order to standardize the output produced, each test script preferably produces a standard header and a standard trailer. Each test program is preferably processed sequentially and individually. Testing functions are performed off-line in order to avoid unnecessary disruption of network operations.

The third component of the software system is a security policy database. The files contained in the security policy database describe the security characteristics or policies of a desired hardware or communications network, preferably in the form of a list that describes which test(s) must be applied on which device(s).

The fourth and fifth components of the software system includes a validation engine and a parser engine, which work in communication with each other, to perform modeling and computational processing of all information. The validation engine interrogates the configuration repository, test scripts and security policy databases for pertinent information. Alternatively and optionally, the validation engine also communicates with the connectivity database. Also, the validation and parser engines output reports providing compliance verification information on hardware and on a communications network.

Through interrogation with the validation engine, the parser engine instantiates computations on the connectivity of network nodes, and generates mapping of critical points of security failure across the nodes comprising the communications network.

In another aspect of the invention, an access control list (ACL) validation tool is disclosed. By analyzing access control lists as they are actually implemented in one or more network devices, the ACL validation tool determines how messages are consistently permitted or denied in each device or across a communications network comprising multiple devices. Alternatively, the ACL validation tool generates optimal ACL rules.

A decision logic of the ACL validation tool includes accessing one or more object references in the form of one or more ACL rules; accessing at least one permission flag associated with each object reference; modeling each object reference as a geometric figure; detecting an intersection of one or more geometric figures; and generating a “pass”/“fail” output based on the intersection of the geometric figures.

In yet another aspect of the present invention, a configuration validation tool is disclosed. The configuration validation tool determines whether a network device is operating in accordance with its security policy and/or its intended functionalities and features; that is, whether the network device is set-up operationally it is expected. The network device may be a router, bridge, hub, gateway or the like.

A decision logic of the configuration validation tool includes accessing one or more configuration files; applying one or more tests to each configuration file, each test describing a desired configuration characteristic of the network device; and generating an assessment report providing one or more indicators on the compliance of the configuration of the device. A network device configuration change request may also be generated.

In yet another aspect of the present invention, a communications network security policy compliance verification tool is disclosed. The communications network security policy compliance verification tool determines whether the set-up of a communications network, as opposed to an individual network device, is in accordance with the network's intended security characteristics. In addition, this tool is useful for determining other characteristics of the communications network, such as the overall network device membership in the communications network, whether a customer is separated from the network, fault management type information, etc.

A decision logic of the communications network security policy compliance verification tool includes accessing configuration files of substantially all network devices in the communications network; extracting connectivity information from the configuration files; applying at least one of network algorithms and modeling to the configuration files and connectivity information in order to develop a map of the network, preferably in the form of a directed or undirected graph; and generating an assessment report providing one or more indicators on the compliance of the security policy of the communications network, including a directed graph. A configuration change request relating to the communications network's security policy and features may also be generated.

There has been outlined, rather broadly, the important features of the invention in order that the detailed description thereof that follows may be better understood, and in order that the present contribution to the art may be better appreciated. There are, of course, additional features of the invention that will be described hereinafter and which will form the subject matter of the claims appended hereto.

It is to be understood that the invention is not limited in its application to the details of construction and to the arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may be readily used as a basis for the designing of other structures, methods and systems for carrying out the several purposes of the present invention. It is important, therefore, that the claims be regarded as including such equivalent constructions insofar as they do not depart from the spirit and scope of the present invention.

The above features and advantages of the invention, along with the various features of novelty that characterize the invention, are pointed out with particularity in the disclosure and claims annexed thereto. For a better appreciation of the invention, its operating advantages and the specific features and advantages attained by its uses, reference should be had to the accompanying drawings and description, which illustrates preferred embodiments of the invention.

### BRIEF DESCRIPTION OF DRAWINGS

FIG. 1 is a diagram of the components of the software system in accordance with a preferred embodiment of the present invention.

FIG. 2 is an illustration of exemplary test scripts usable with the software system of FIG. 1.

FIG. 3 is a flow chart of the decision logic of a test script shown in FIG. 2.

FIG. 4 is a flow chart of the decision logic of a test script in FIG. 2 useful for diagnosing access control list (ACL) consistency issues.

FIG. 5 is an exemplary ACL having four rules.

FIG. 6 is a graph of the ACL in FIG. 5 modeled as geometric figures, in accordance with a preferred technique of intersection detection of the present invention.

FIG. 7 is flow chart of a decision logic for determining security policy compliance verification on a local basis, in accordance with a preferred embodiment of the present invention.

FIG. 8 is flow chart of a decision logic for determining security policy compliance verification on a global basis, in accordance with a preferred embodiment of the present invention.

FIG. 9 is a flow chart showing an alternative embodiment of the software system of the present invention.

FIG. 10 is a diagram showing in more detail the parser engine of the software system of FIG. 1.

### DETAILED DESCRIPTION OF EMBODIMENTS

The present invention is directed to a software system and/or method for providing configuration compliance verification information on security policy and functional capabilities. For each of the two levels of compliance verification, the system provides compliance verification information locally with respect to an individual network device, or globally with respect to a collection of network devices, such as a communications network. The software system comprises five components.

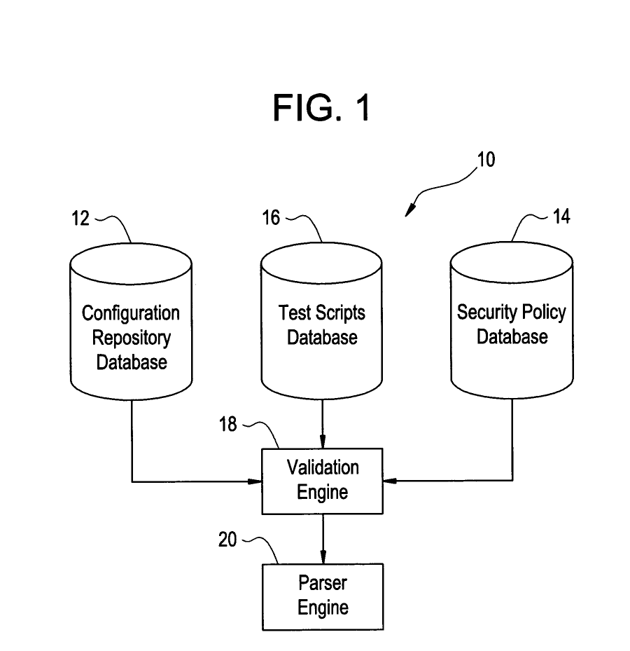

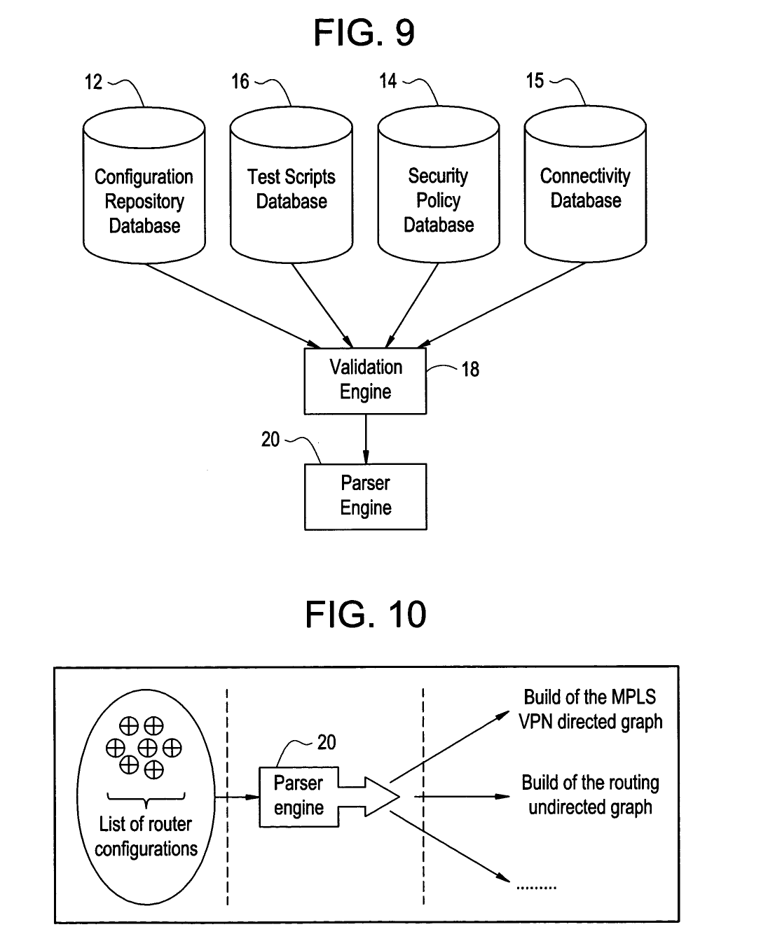

Referring now to FIG. 1, there is shown a preferred embodiment of the software system 10 of the present invention. It comprises a configuration repository database 12, a security policy database 14, a test scripts database 16, a validation engine 18 and a parser engine 20. Alternatively and optionally, the system 10 may comprise a connectivity database 15 (FIG. 9) as discussed later.

The configuration repository database 12 contains information on the way in which each network device is set up both in terms of hardware and software.

The term, “hardware”, as used herein refers to the physical components of a computer or communications system. Hardware includes, but is not limited to, peripheral equipment, such as printers, modems and mouse devices. Hardware also includes network equipment and devices, such as routers, bridges, hubs, gateways and the like.

As to the hardware, the configuration repository database 12 contains configuration files that describe the characteristics of its function. That is, each configuration file in the repository database 12 represents or corresponds to a configuration file describing the characteristics of how a hardware or network device functions. Configuration files are machine-readable operation specifications associated with a specific network device. It tells a router, for example, how to behave when receiving messages, as well as where and how to forward them.

The second component of the software system 10 is a security policy database 14, which contains information describing the way in which a network device and/or communications network is/are designed to be protected against harm or loss. As to hardware, the security policy database 14 contains files that describe the security characteristics or policies of hardware. Preferably, each file in the security policy database 14 represents or corresponds to the security characteristics that a network device is intended to implement.

The third component of the software system 10 is a test scripts database 16. The test scripts database contains a collection of test scripts or expert rules that expresses a security characteristic or policy as a test. The test scripts are programs, which may be written in any programming language, such as shell scripts, C programs and the like. Preferably, the test programs are coded using shell scripts.

An advantage of the programming flexibility of the test programs is that it is easy to code and easy to transport from one platform to another. Additionally, programming flexibility allows the test programs to be user-definable because it allows a broad range of different users to write their own test scripts in their favorite language, or in a language that facilitates more direct coding.

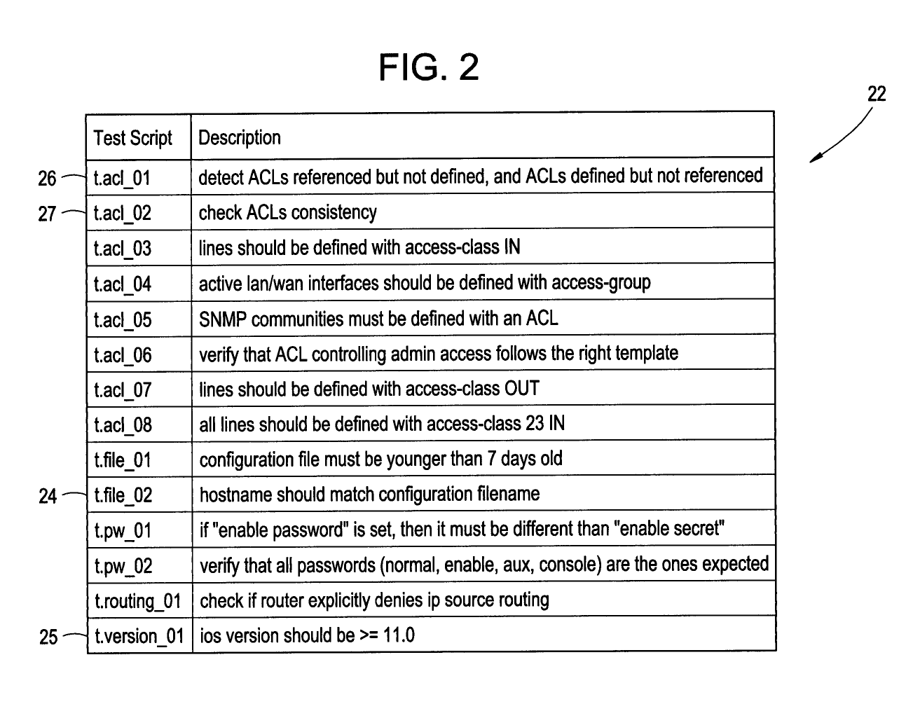

FIG. 2 provides an exemplary list 22 of test scripts usable in the software system 10 of the present invention. As depicted, the test scripts are of varying levels of complexity. Some tests are relatively easy to code and involve less complex rules, such as pattern-matching techniques, as exemplified in test program 24. Test program 24 employs Global Regular Expression Print (grep) searching, which searches a file or files by keyword followed by a string comparison.

Other tests depicted in FIG. 2 involve moderately complex rules, which are context-dependent and require advanced parsing techniques, as exemplified by test program 26. Test program 26 uses contextual parsing techniques in order to extract all references of access control lists (ACLs) in a configuration file. The definitions of ACLs as well as the references of ACLs are stored in set data structures, and the test program 26 uses advance set manipulation techniques, such as computing weak subsets and set equivalence, in order to accomplish the programs s objective.

In addition, other tests involve complicated rules that require both advanced parsing techniques, mathematical modeling and analysis, such as test program 27. Implementation of test program 27 requires observance of the ACL syntax rules by a parser in order to extract all information. Preferably, a Yet Another Compilers Compiler (YACC) generated parser is employed. Test program 27 then translates ACL rules into geometric figures over which one or more intersections are computed. As discussed with reference to FIG. 8 below, the logic of test program 27 may take the form of a software module useful for providing ACL compliance verification and/or security compliance verification.

Any number of test scripts may be developed for storage in the test scripts database 16. The inventors have developed over 100 test scripts usable in the present invention. In a preferred embodiment, each test script is designed to output a pass/fail result in the form of a standard header and trailer in order to standardize the output to the validation engine 18. Alternatively, a test script may output a complex result.

The validation engine 18 interrogates the configuration repository database 12, the security policy database 14 and the test scripts database 16 for data in order to accomplish, in part, its function of sequentially applying one or more test programs, as desired, to the configuration files and/or security policies of one or more individual network devices, as desired. The validation engine 18 also operates in communication with the parser engine 20 to facilitate any post-execution parsing functions.

In keeping with the present invention, the software system 10 produces compliance verification information with respect to a security policy. This verification may be performed with respect to a single network device (i.e. local analysis) or with respect to the connectivity of multiple network devices comprising a communications network (i.e. global analysis). Before discussing these compliance verifications, a more detailed discussion of testing is provided below.

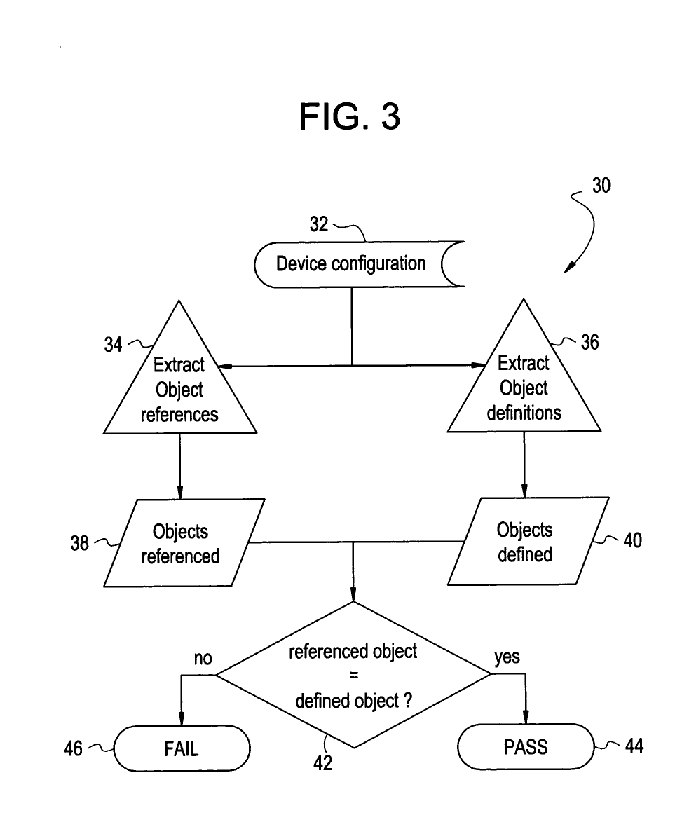

Referring now to FIG. 3, there is shown an illustrative example of the decision logic 30 of a test script, in accordance with a preferred embodiment of the present invention. More particularly, the test script is test program 26 from FIG. 2.

Generally, test program 26 is a test developed to identify or assess usage of Access Control Lists (ACLs). In the context of network devices, an ACL is a list of rules describing which messages are allowed or denied transit through the network device. ACLs are associated with communication links, device management access or other message paths. Other uses of ACLs are for controlling user access for files in computers.

As depicted in FIG. 2, the test program 26 implements the security policy requiring that all ACL definitions must be referenced and that all ACL references must be defined. Generally, the programming logic of test program 26 requires a comparison of definitions versus references of any kind of object, as shown in FIG. 3. In the instance of the test program 26, the object is an ACL. Alternatively and optionally, the object may be a user account or a device's functional capability.

For each device's configuration, as at 32, the validation engine 18 extracts from the configuration repository database 12 one or more references, as at 34, and one or more definitions, as at 36, involving an ACL. Once all or a set of ACLs are referenced, as at 38, and all or a set of ACL definitions are defined, at 40, the validation engine 18 performs comparison matching, as at 42. Here, the relevant comparison matching inquiry 42 is whether the referenced object matches the defined object.

If the set of ACLs referenced exactly matches the set of ACLs defined, the test program 26 outputs a “pass” result 44. In other words, the test program 26 succeeds if and only if ACL definitions are consistent with ACL references. On the other hand, if the comparison matching is not equal, the test program 26 outputs a “fail” result 46. Alternatively and optionally, the test program 26 may output a “fail” result 46 along with a list of all objects referenced but undefined, and a list of all objects defined but unreferenced.

Notably, the test program 26 is a valuable tool in diagnosing the security vulnerability of a network device particularly where the internal operating systems of the network device does not flag undefined ACL references. Non-flagged, undefined ACL references are commonplace in current network devices and constitute instances where network security assessments are generally overlooked.

Because ACL is the core mechanism on which substantially all network security lies, further discussion and illustration on how the software system 10 of the present invention solves the difficult problem of verifying and validating ACL consistency is presented below. More particularly, the solution is presented using the invention's pass/fail decision logic.

In typical network operation, ideally all the rules that define an access control list refer to distinct addresses, ports and protocols. However, it is not unusual to find two or more different rules that describe the same address, port and/or protocol. In such instances, these rules are essentially describing the same message flow. When this occurs, the ACL described by the plurality of rules is not optimal. Decision logic 50 solves this dilemma by identifying such rules and/or generating optimal ACL rules.

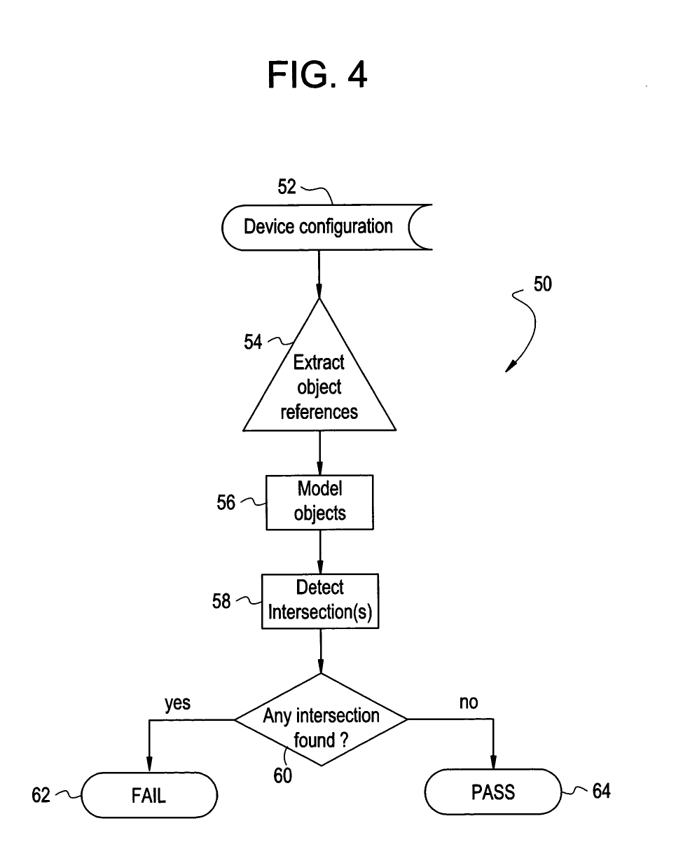

Referring now to FIG. 4, there is shown an exemplary decision logic 50 useful for diagnosing ACL consistency problems in hardware in accordance, for example, with a test script in the form of the test program 27 shown in FIG. 2. Decision logic 50 permits detection of substantially all partially or totally redundant and inconsistent lines within a given ACL. Decision logic 27 is based, in part, on advanced parsing techniques and mathematical modeling. As demonstrated below, the logic's output may be filtered so that a chosen subset of the diagnostics produced is disregarded.

As depicted, for each device's configuration file, as at 52, the validation engine 18 performs an extraction process, as at 54, in which it extracts all ACL rules (i.e. object references in the form of ACL definitions) from the configuration repository database 12. Preferably, each ACL rule and/or extended ACL rule, such as an Internet Protocol (IP) ACL rule, is represented in a six-dimensional space defined by the following six dimensions: (1) the internet protocol, such as Internet Control Message Protocol (ICMP), Transmission Control Protocol (TCP), User Datagram Protocol (UDP), and the like; (2) the source IP address range; (3) the source ports, when applicable; (4) the destination IP address range; (5) the destination ports, when applicable; and (6) one protocol-related permission flag associated with a given ACL rule. The permission flag is tagged as either “permit” or “deny”. Depending on the nature of the network device, alternate dimensions may be defined according to the syntax and semantic of the ACL analyzed.

After the extraction process 54, the ACL rules are modeled, as at 56, preferably as multi-dimensional geometric figures, such as solids, rectangles and the like. In effect, the task of detecting ACL inconsistencies is easily reduced to intersection detection, as at 58, between one or more solids where overlapping areas between solids represent substantially redundant and/or inconsistent lines within a given ACL.

The decisional inquiry, as at 60, is whether an intersection exists between solids. If there are intersecting solids, the ACL represented by the intersecting solids are treated as being redundant and/or inconsistent, and therefore fails, as at 62. Otherwise, the entire ACL passes, as at 64.

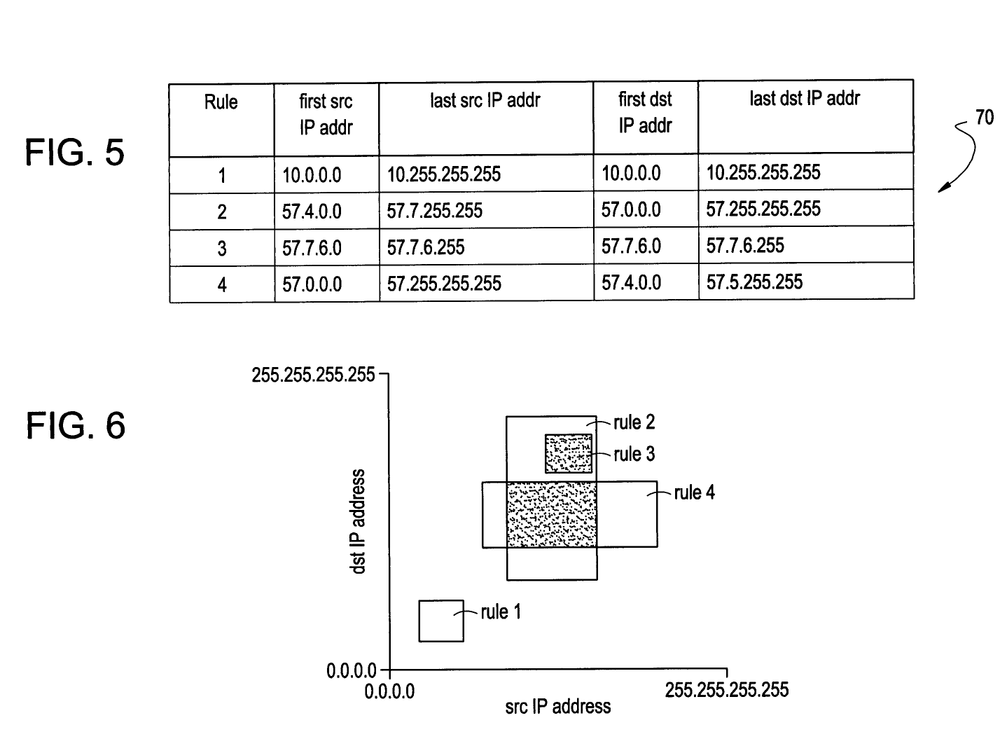

For a better appreciation of the unique aspects of the ACL rules modeling and detection intersection techniques of the decision logic 50 of test program 27, a further example (FIG. 5) is instructive. Notably, decision logic 50 of test program 27 may take the form of a software module.

Referring now to FIG. 5, there is shown an access control list 70 consisting of four rules—Rules 1, 2, 3 and 4.

FIG. 5 summarizes the source and destination address ranges for Rules 1-4 of the ACL 70. Because each ACL rule includes a source address range (i.e. the first source IP address and the last source IP address) and a destination address range, all four ACL rules are modeled as a set of four rectangles. Employing the technique of intersection detection between Rules 1-4 within the ACL 70 produces the graph of FIG. 6. The shadowed areas show intersections between the rectangles; namely, Rules 2, 3 and 4.

A review of FIG. 6 indicates that Rule 1 is independent of Rules 2, 3 and 4. Interpretively, this means Rule 1 describes a message flow totally independent of Rules 2, 3 and 4. Accordingly, the intended meaning of Rule 1 is not modifiable or likely to be modified by Rules 2, 3 and 4.

On the other hand, Rule 3 falls completely within Rule 2—Rule 3 is a proper subset of Rule 2—and Rule 2 intersects with Rule 4. In order to correctly interpret both results, it is important to assess the permission flag associated with Rules 2, 3 and 4. Depending on a rule's permission flag status, the rule is determined as being either redundant or inconsistent.

For example, as to the intersecting area of Rules 2 and 3, if the permission flag for both rules is “permit” (or alternatively both flags are “deny”), this means that the intersecting area of Rules 2 and 3 (i.e. Rule 3 in its entirety) is treated as being redundant. More specifically, it means that Rule 3 is completely redundant, and Rule 2 is partially redundant with respect to the intersecting/shaded area it shares with Rule 3. Rule redundancy means that more than one rule describe the same message flow and, therefore, some rules are useless. This situation, although valid, is error-prone because if one rule is modified, the modification must be reflected in the other redundant rules.

Alternatively, if the permission flag for Rule 3 is “permit” and the permission flag for Rule 2 is “deny”, or vice versa, this means that the intersecting area of Rules 2 and 3—namely Rule 3 in its entirety—is inconsistent. Rule inconsistency means that a message flow is both permitted and denied. As in the redundancy scenario, while this situation may be technically valid, it is either logically incorrect or, at best, error prone.

In summary, the intersecting (shaded) area of rectangles 2 and 3 represented by Rules 2 and 3 depicted in FIG. 6 indicate that Rule 3 is completely redundant, is not optimal and, therefore, should be discarded.

A similar analysis holds true for Rules 2 and 4. The intersecting (shaded) areas of Rules 2 and 4 correspond to a specific message flow that is described by both Rule 2 and Rule 4. If the permission flags for both rules are the same, then Rules 2 and 4 are partially redundant with respect to the intersecting (shaded) area. If the permission flags for both rules are different, this means that Rules 2 and 4 are partially inconsistent with respect to their intersecting (shaded) area. In both scenarios, the situation is, at best, prone to error because if Rule 2 is modified, then Rule 4 must also be modified in order to keep the same behavior.

To summarize, as to Rules 1 through 4, because Rules 2, 3 and 4 are intersecting solids, the ACL represented by these rules fail, as at 62. Alternatively, because Rule 1 is not an intersecting solid, the ACL represented by Rule 1 passes, as at 64.

It is important to recognize that the geometric modeling technique employed by the test program 27 allows for validation and optimization of an ACL. Test program 27 may also be used to output a sanitized and optimized ACL with respect to different optimization criteria. For instance, the test program 27 is designed to output ACL rules that do not intersect, in effect, ensuring that each message flow is described by a single ACL rule. Alternatively, the test program 27 may be designed to output an ACL with the smallest number of rules, as desired.

As a final observation about the test program 27, which employs geometric modeling and intersection detection techniques to identify/diagnose ACL inconsistencies and redundancies, note that the test program 27, like other test scripts in the list 22, follows the syntax and semantic of the internal operating systems of the hardware.

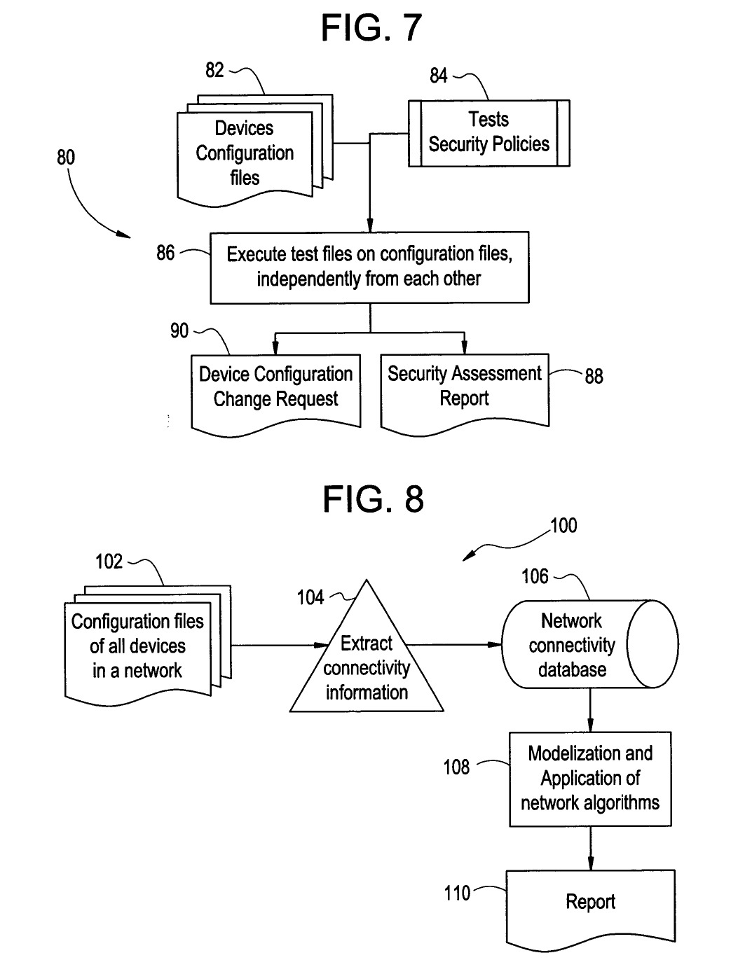

Referring now to FIG. 7, there is shown a preferred decision logic 80 for determining compliance verification with respect to a security policy. In this instance, compliance verification is performed on a local basis, with respect to a desired hardware such as a router.

As illustrated, one or more files 82 containing information describing the characteristics, behavior and configuration of a desired hardware is retrieved from the configuration repository database 12 for input into the validation or loop engine 18. Here, the object (or objects) to be analyzed is the desired router. The files 82 include information of the router's location, type and the like. In a preferred embodiment, the network device is not accessed or probed by the software process 80. Substantially all analyses are performed off-line based on the configuration files 82.

Similarly, programmed files 84 containing information on the router's expected behavior in the form of one or more tests or a series of tests, are retrieved from the test scripts database 16 for input into the validation engine 18. Alternatively and optionally, one or more tests or test programs or a series of tests or test programs may take the form of one or more software modules as desired.

The router configuration files 82 and the test program files 84 are executed sequentially, as at 86, by the validation engine 18 and/or parser engine 20 in accordance with coded instructions, of which test to apply on which router, from files in the security policy database 14. By performing a desired number of test programs on the configuration files of a desired router that is the subject of compliance validation, the validation engine 18, optionally in communication with the parser engine 20, sequentially performs all tests against the way in which the router delivers messages, and performs the above compliance validation process independently for each router. In this regard, compliance verification is performed substantially assessing the security aspects of the router.

In a preferred embodiment, the validation engine 18 is designed to output one or more security assessment reports 88 on the compliance validation/verification results of a desired hardware. In this instance, the security assessment report 88 provides a security compliance assessment on the router.

For example, the validation engine 18 outputs details related to the router's failure. Preferably, the details are presented in the form of a line number of a non-complying configuration item in the router's configuration file 82, the incorrect item found, its expected format, and the severity level.

The assessment report 88 provides the security compliance assessment on an easy-to-read “pass” or “fail” basis. For example, a report may state that test script ABC failed on router XYZ, and that the test script CBA passed on router ZYX.

A security dashboard may also be generated based on various security assessment reports 88 over a desired time period. The security dashboard preferably includes statistics on the number of security faults detected, sorted by severity levels and/or over a time period. Other statistics, such as the percentage of incorrect network devices in a communications network, may be derived. The security dashboard is intended to provide an overview or high-level summary and key indicator of the security status of a single network device and/or multiple network devices in a communications network.

In addition, the validation engine 18 may produce one or more network device configuration change requests 90. These configuration change request reports contain information substantially similar to information contained in the security assessment reports 88. However, configuration change requests 90 are transmitted to a trouble-shooting system where network operators receive correction request messages.

The software system 10 of the present invention is also useful for determining compliance verification with respect to a security policy on a global basis; that is, with respect to the connectivity of a plurality of network devices within a communications network.

More particularly, FIG. 8 shows a preferred decision logic 100 for evaluating security compliance verification on a global basis. Here, the objects to be analyzed are the plurality of network devices as a whole, representative of the communications network.

As illustrated, the configuration files 102 of all the network devices in a desired communications network for examination, is retrieved from the configuration repository database 12 for input into the validation engine 18. The validation engine 18 performs a connectivity extraction process 104 that is tailored to the type of communications network under compliance verification. For example, the communications network may include a virtual private network (VPN) built over a backbone, Internet Protocol Security (IPSec) VPNs, backbone internal or external routing and the like. Alternatively, a software module performs the connectivity extraction process 104.

The extraction process 104 may be performed in various ways depending on the syntax structure of the device configuration. For example, where the hardware is a router, some router configuration files may be parsed using command tools such as Practical Extraction and Report Language (PERL), Global Regular Expression Print (GREP) and the like. Other router configurations, because of their hierarchical syntax structure, require parsing using recursive-capable parsers such as those generated by Yet Another Compilers' Compiler (YACC).

In extracting connectivity information from the configuration files 102, the validation engine 18 builds a connectivity database 106. Alternatively and optionally, a connectivity database 15 (FIG. 9) may be populated with communications network connectivity information.

The extraction process 104 and the connectivity database 15 preferably yields information on the route cost metric associated with each communication link and/or network device. A route cost metric is an indication of how efficient a data link is, and is used by the network devices to forward data messages efficiently. Shortest paths and single-source shortest paths between routers may also be derived from the routing cost metrics information. The extraction process 104, which may take the form of a software module, also extracts core backbone internal routing information with associated cost metrics and this information populates the connectivity database 106 also.

Preferably, the connectivity database 106 is a relational database, which is used as the basis for all subsequent computations. The connectivity database 106 communicates with the test scripts database 16 via the validation engine 18, which models, as at 108, the connectivity information of the communications network as a directed or undirected graph. For example, in a directed graph, each edge of the communications network links two nodes together in one direction only. In an undirected graph, node linkages may be illustrated in more than one direction.

In addition, the validation engine 18, in communication with the connectivity database 106, applies one or more network algorithms, as at 108, to the connectivity information in database 106 to determine instances of breach or failure of the global communications network security policy. These instances are output in security assessment reports 110, which provide a security assessment on the communications network. Reports 110 are substantially similar to the reports 88 previously discussed, including automatic transmission of communications network change requests to one or more network operational teams for correction. Additionally, the discussion on security dashboard above applies equally to reports 110.

It is important to note that the decision logic 100 of a global analysis differs from the decision logic 80 of a local analysis in two significant ways. First, the decision logic 100 of the global analysis does not produce as an output a “pass”/”fail” result. Instead, a security compliance verification performed on a global basis produces a complex result, preferably expressed in terms of graph-oriented predicates that indicate, for example, single points of failure or the perimeter of a virtual private network, as discussed in further detail below.

Second, the focus of decision logic 100 of the global analysis is not on an individual hardware, but rather on multiple network devices. As such, the global analysis decision logic 100 has value as a network engineering tool that is useful in determining, for example, all the router members of a desired virtual private network as well as verifying whether a customer is separated from all other VPNs.

With respect to determining all the routers in a network, the following explanation on how the decision logic 100 of FIG. 8 is useful to determine the overall network device membership in a virtual private network (VPN), is here presented.

VPN services are implemented using an Internet protocol called Multi-Protocol Label Switching (MPLS) that allows computers to establish general physical links. In the MPLS model, a virtual private network is associated with a virtual forwarding table (VRF), which implements logical connections by bringing in (importing) and moving out (exporting) information on route target (RT) extended communities. For a virtual private network having any-to-any IP connectivity, the route targets used in the import and export statements are identical and exchanged in a symmetrical manner for all VPN access points. For a VPN with many-to-few IP connectivity, the route targets are exchanged asymmetrically.

Notably, substantially all VPN definitions are implemented on provider edge (PE) routers. More particularly, in order to implement a MPLS VPN, the configuration information on PE routers, contained in configuration files 102, must include information regarding: (1) association of a customer edge (CE) router with a sub-interface; (2) association of a sub-interface with a virtual forwarding table (VRF); (3) VRF route target import rules; and (4) VRF route target export rules.

In extracting connectivity information from all the PE routers configuration contained in configuration files 102, the validation engine 18 preferably builds a relational connectivity database 106. The relational database 106 contains information on: (1) the name or names of the customer edge (CE) router or routers; (2) the name or names of the provider edge (PE) router or routers; (3) the name of the VPN's virtual forwarding table, its route distinguisher and route targets; (4) the action (export or import) performed; and (5) the route target exported or imported.

The relational connectivity database 106 is used as the basis for substantially all subsequent computations and modeling of the above data. The parser engine 20, as shown in FIG. 10, in connection with the validation engine 18, processes the information in the relational database 106 to develop a conceptual directed graph, as at 108, that models substantially all MPLS VPNs implemented on the IP backbone.

Referring to FIG. 10, there is shown the parser engine 20 of FIG. 1 and how it is used to alternatively develop an undirected graph of routing information. Using the parser engine 20, the software system 10 of the present invention computes articulation points on the undirected graph, which provides valuable information on single points of failure.

An articulation point is the graph-theoretic equivalent concept of a single point of failure in a communications network. The absence of an articulation point in a communications network means that the associated communications network is fault-tolerant with respect to a network device. It is possible to construct an alternate graph where articulation points represent communication links. Consequently, an important value in the use of the graph-theoretic model of a communications network is the ability to identify non-fault-tolerant, critical network devices and communication links, since these devices and communication links will isolate parts of a communications network if they fail.

The parser engine 20 also generates a map of the critical points of failure for both routers and links in a communications network. The mapping process is applicable on level-2 networks, such as X.25 and Frame Relay, IP networks and the like. Additionally, the parser engine 20 computes backbone fault-tolerance and asymmetric routes, as at 108.

Revisiting the modeling and algorithmic processing performed, as at 108 in FIG. 8, it is apparent that the decision logic 100 facilitates the derivation of more than device membership of a MPLS VPN as discussed above. From a single customer edge (CE) router, connectivity data is manipulable to determine a list of substantially all other CE routers having a forward IP route from a specified CE router. Similarly, using a backtrack approach, a list of substantially all CE routers having a backward IP route is easily derived.

The significance of this forward/backward depth-first search approach lies in the ability to compute the strongly connected components of the VPNs directed graph. Additionally, based on the IP routes distribution, computing the set of all CE routers of a same VPN or for substantially all VPNs, is easily derived. What is more, from the connectivity data, the perimeter of substantially all VPNs, as opposed to a single VPN, is easily determined.

In one embodiment of the present invention, the decision logic 50 of FIG. 4 comprises an ACL validation tool, which has value in several contexts. First, the ACL validation tool determines how data messages are consistently permitted or denied across a communications network. It helps network operators identify which hardware ACL inconsistencies exist by analyzing ACLs as they are actually implemented in one or more network devices. Second, the ACL validation tool is useful as a stand-alone tool, preferably in the form of a software module. Third, the ACL validation tool is useful in the management of very long access lists by quickly detecting incoherent or useless ACL rules. Fourth, maintenance of this tool is easy as it generally involves updating the program logic to follow syntax and semantic evolution of ACL definitions when they are changed/released.

In another embodiment of the present invention, the decision logic 80 of FIG. 7 comprises a configuration validation tool, which has value in several contexts. First, the configuration validation tool may be used as one component of a corporation's security audit on the IP backbones in order to help network operators quickly verify/validate whether a network device is operating in accordance with its intended functionalities, including its security policy. Second, the configuration validation tool is useful in security event management such as in instances where a bug is reported or has developed in one or more devices. One value of this tool is the ease with which the programming logic may be modified and implemented to determine a list of devices requiring patches or other repair work. Third, the configuration validation tool is useful as a stand-alone tool, preferably in the form of a software module. Fourth, this tool is easy to maintain; generally it simply requires updating the program to follow syntax and semantic evolution of router features when they are released.

In yet another embodiment of the present invention, the decision logic 80 of FIG. 7 comprises a network device security policy compliance verification tool, which has value in several contexts. First, the network device security policy compliance verification tool is usable in security audits of network architecture to quickly and efficiently determine whether hardware is operating in accordance with its intended security policy. This is particularly useful in architectures that employ different IP backbones and consequently implement different security policies. Second, the network device security policy compliance verification tool is also useful for verifying security policy compliance with new devices before deployment as well as with existing devices. Third, the tool is useful to identify security vulnerabilities in network devices, such as single points of failure, at an instant or over a period of time. Fourth, the tool is also useful for trouble-shooting management.

In yet another embodiment of the present invention, the decision logic 100 of FIG. 8 comprises a communications network security policy verification tool, which has value in several contexts. First, this tool is a useful compliance verification tool in communications network audits, for instance, to determine all reachable devices; provide route leakages; verify separation between two or more VPNs, for example; determine strongly connected components of the communications network; determine single points of failures; determine the perimeter of a communications network; and the like. Second, the tool is also useful to identify vulnerabilities on a customer's communications network. Third, the tool is useful to improve fault management.

It is important to note also that one or more enhancements to the present invention are programmable, such as a security policy compiler. The security policy compiler translates a high-level description into test software modules.

The above embodiments are only to be construed as examples of the various different types of computer systems, methods, logic, etc., that may be used in connection with the computer-assisted and/or -implemented process of the present invention.

The many features and advantages of the invention, as provided by the above description and drawings, are illustrative of preferred embodiments presented in the detailed specification. It is intended by the appended claims to cover all such features and advantages of the invention that fall within the true spirit and scope of the invention.

Further, it is not desired to limit the invention to the exact construction and operation illustrated and described. Accordingly, all suitable modifications and equivalents that come within the spirit and scope of the invention is considered to be part of the present invention.

What is claimed is:

1. An access control list (ACL) validation module for detecting at least one of ACL inconsistencies and redundancies in a network device, said module including decision logic for:
(a) accessing one or more object definitions in the form of one or more ACL rules;
(b) accessing at least one permission flag associated with each ACL rule;
(c) modeling each ACL rule as a geometric figure;
(d) detecting an intersection of each modeled geometric figure; and
(e) generating a binary output based on the intersection of the geometric figures.

2. The module according to claim 1, further including a step of extracting substantially all ACL rules from a configuration database.

3. The module according to claim 1, further including a step of tagging each permission flag as either permit or deny.

4. The module according to claim 1, further including a step of representing each ACL rule in a six-dimensional space.

5. The module according to claim 4, wherein one dimension of said six-dimensional space is defined by an internet protocol.

6. The module according to claim 4, wherein one dimension of said six-dimensional space is defined by a source internet protocol address range.

7. The module according to claim 4, wherein one dimension of said six-dimensional space is defined by one or more source ports.

8. The module according to claim 4, wherein one dimension of said six-dimensional space is defined by a destination internet protocol address range.

9. The module according to claim 4, wherein one dimension of said six-dimensional space is defined by one or more destination ports.

10. The module according to claim 1, including multi-dimensional modeling of each geometric figure in the modeling step.

11. The module according to claim 1, employing at least one of a circle, rectangle and solid as a geometric figure in the modeling step.

12. The module according to claim 1, further including a step of incorporating a status of said permission flag in the modeling step.

13. The module according to claim 1, having a step interpreting the intersection of two or more figures to represent an existence of substantially all partial or total ACL redundancies or inconsistencies.

14. The module according to claim 1, having a step interpreting a non-intersecting figure to represent substantially no partial or total ACL redundancies or inconsistencies.

15. The module according to claim 1, having said output comprise pass or fail.

16. The module according to claim 15, wherein a pass output result is indicative of substantially no intersecting figures.

17. The module according to claim 15, wherein a fail output result is indicative of an existence of substantially all partial or total ACL redundancies or inconsistencies.

18. The module according to claim 1, having said output comprise optimization of an ACL.

19. A configuration validation module for providing compliance verification information on an intended functionality of a network device, said module including decision logic for:
(a) accessing one or more configuration files of the network device;
(b) accessing one or more test files, each test file describing an expected configuration characteristic of the network device;
(c) accessing one or more security policy files, each security policy describing which test to apply on which network device and an expected outcome of each test;
(d) applying one or more test and security policy files to the one or more configuration files; and
(e) generating an output indicative of configuration compliance of the network device.

20. The module according to claim 19, further including a step of extracting substantially all configuration files a database.

21. The module according to claim 19, further including a step of extracting substantially all test files from a database.

22. The module according to claim 19, further including a step of extracting substantially all security policy files from a database.

23. The module according to claim 19, having a step of sequentially executing each test and security policy file on each configuration file, said step of sequentially executing included in the applying step.

24. The module according to claim 19, having a step of executing each test and security policy file on each configuration file for each network device, said step of executing included in the applying step.

25. The module according to claim 19, having said output comprise pass or fail.

26. The module according to claim 19, having said output comprise a security assessment report.

27. The module according to claim 19, further including a step of generating a network device configuration change request.

28. The module according to claim 27, further including a step of transmitting said configuration change request to a trouble-shooting system.

29. A network device security policy module for verifying security compliance of the device's configuration, said module:
(a) accessing one or more configuration files of the network device;
(b) accessing one or more test files, each test file describing an expected configuration characteristic of the network device;
(c) accessing one or more security policy files, each security policy describing which test to apply on which network device and an expected outcome of each test;
(d) executing the test and security policy files on the configuration files; and
(e) generating a security assessment report on the network device.

30. The module according to claim 29, further including a step of generating a network device configuration change request.

31. The module according to claim 30, further including a step of transmitting said configuration change request to a network operator.

32. A network device security policy module for providing security compliance verification on a configuration of a network device, said module:
(a) accessing one or more configuration files of the network device;
(b) accessing one or more test files, each test file describing an expected configuration characteristic, including a security policy characteristic, of the network device;
(c) applying one or more test files to each configuration file of the device; and
(d) generating an output indicative of configuration compliance of the network device.

33. The module according to claim 32, wherein each accessing step includes extracting one or more of said configuration files and said test files from a database.

34. The module according to claim 32, having a step of sequentially executing each test file on each configuration file, said step of sequentially executing included in the applying step.

35. The module according to claim 32, having a step of executing each test file on each configuration file for each network device, said step of executing included in the applying step.

36. The module according to claim 32, having said output comprise pass or fail.

37. The module according to claim 32, having said output comprise a security assessment report.

38. The module according to claim 32, further including a step of generating a network device configuration change request.

39. The module according to claim 38, further including a step of transmitting said configuration change request to a fault management system.

40. A communications network security policy module for verifying configuration compliance of a communications network, said module performing the functions of:
(a) accessing configuration files of substantially all network devices in the communications network;
(b) extracting communications network connectivity information from the configuration files;
(c) manipulating connectivity information by employing at least one of network algorithms, modeling and parsing techniques; and
(d) generating an output indicative of security policy compliance verification of the communications network.

41. The module according to claim 40, performing the extracting step in accordance with a desired communications network.

42. The module according to claim 40, having a step of developing a connectivity database included in the extraction step.

43. The module according to claim 40, further including a step of accessing route cost information associated with each communication link.

44. The module according to claim 40, further including a step of accessing route cost information associated with each network device.

45. The module according to claim 40, having a step of modeling connectivity information of the communications network as a directed graph, included in the manipulating step.

46. The module according to claim 40, having a step of modeling connectivity information of the communications network as an undirected graph, included in the manipulating step.

47. The module according to claim 40, further including a step of generating a communications network configuration change request.

48. The module according to claim 40, said output comprising one or more graph-oriented predicates.

49. The module according to claim 40, further including a step of transmitting said configuration change request to a fault management system.

50. A software system for providing security policy compliance verification on a network device, said software system comprising:
(a) a configuration database including one or more configuration files containing information describing an arrangement of the network device;
(b) a test database including one or more test files containing information describing one or more tests, which express one or more expected characteristics, including one or more security characteristics, of the network device;
(c) a security policy database including one or more security policy files containing information describing which test to apply on which device and an expected outcome of each test; and
(d) a validation engine, which communicates with the configuration, test and security policy databases, for processing information of said configuration, test and security policy databases, and generating an output verifying security policy compliance of the network device.

51. The software system of claim 50, wherein each test is written in any programming language.

52. The software system of claim 50, wherein each test produces a standard header and a standard trailer.

53. The software system of claim 50, said validation engine sequentially applying one or more test files and security policy files to the configuration files.

54. The module according to claim 50, said output comprising one or more graph-oriented predicates.

55. A software system for providing security policy compliance verification on a communications network, said software system comprising:
(a) a configuration database including one or more configuration files containing substantially all connectivity information describing an arrangement of the communications network;
(b) a test database including one or more test files containing information describing one or more tests, which express one or more expected security characteristics, of the network device;
(c) a security policy database including one or more security policy files containing substantially all information describing which test to apply on which device in the network and an corresponding expected result of applying the test on the device; and
(d) a validation engine, in communication with at least one of the configuration, test and security policy databases, for processing information of said configuration, test and security policy databases; and
(e) a parser engine, in communication with the validation engine, for instantiating computations on connectivity information and generating an output indicative of security policy compliance verification of the communications network.

56. The software system of claim 55, wherein each test is written in any programming language.

57. The software system of claim 55, wherein each test produces a standard header and a standard trailer.

58. The software system of claim 55, said validation engine sequentially applying one or more test files and security policy files to the configuration files.

59. The software system according to claim 55, said output comprising one or more graph-oriented predicates.

60. The software system according to claim 55, said output comprising an undirected graph of routing information.

61. The software system according to claim 55, said output comprising a directed graph of routing information.

62. The software system according to claim 55, said output comprising a map of one or more critical points of failure for both network devices and links in the communications network.

63. The software system according to claim 55, further including a connectivity database containing connectivity information of the communications network.

64. A computer readable media encoding instructions for detecting substantially all partial or total inconsistencies or redundancies within an access control list, said media including instructions for:
(a) accessing one or more access control list rules;
(b) accessing at least one permission flag for each rule;
(c) modeling each rule geometrically in accordance with an associated permission flag;
(d) detecting an area of intersection of one or more geometric models of the access control list rules; and
(e) generating an output based on the intersection of one or more geometric models.

65. The media of claim 64, further including an instruction for tagging each permission flag as either permit or deny.

66. The media of claim 64, further including an instruction for multi-dimensional modeling of each geometric figure in the modeling step.

67. The media of claim 64, further including an instruction for employing at least one of a circle, rectangle and solid as a geometric figure in the modeling step.

68. The media of claim 64, further including an instruction of incorporating a status of said permission flag in the modeling step.

69. The media of claim 64, having said output comprise pass or fail.

70. The media of claim 64, wherein a pass output result is indicative of substantially no intersecting figures.

71. The media of claim 64, wherein a fail output result is indicative of an existence of substantially all partial or total ACL redundancies or inconsistencies.

72. The media of claim 64, having said output comprise optimization of an ACL.

73. A computer readable media encoding instructions for diagnosing security policy compliance of a network device, said media including instructions for:
(a) accessing one or more configuration files of the network device;
(b) accessing one or more test files, each test file describing an expected configuration characteristic of the network device;
(c) accessing one or more security policy files, each security policy describing which test to apply on which network device and an expected outcome of each test;
(c) executing the test and security policy files on the configuration files; and
(d) generating a security assessment report on the network device.

74. The media of claim 73, further including instructions for generating a network device configuration change request.

75. The media of claim 74, further including an instruction for transmitting said configuration change request to a network operator.

76. A computer readable media encoding instructions for diagnosing security policy compliance of a communications network, said instructions including:
(a) accessing configuration files of substantially all network devices in the communications network;
(b) extracting communications network connectivity information from the configuration files;
(c) manipulating connectivity information by employing at least one of network algorithms, modeling and parsing techniques; and
(d) generating an output indicative of security policy compliance verification of the communications network.

77. A method for detecting at least one ACL inconsistencies and redundancies in a network device, said method comprising the steps of:
(a) accessing one or more object definitions in the form of one or more ACL rules;
(b) accessing at least one permission flag associated with each ACL rule;
(c) modeling each ACL rule as a geometric figure;
(d) detecting an intersection of each modeled geometric figure; and
(e) generating a binary output based on the intersection of the geometric figures.

78. A method for diagnosing compliance of a security policy of a network device, said method comprising the steps of:
(a) accessing one or more configuration files of the network device;
(b) accessing one or more test files, each test file describing an expected configuration characteristic, including a security policy characteristic, of the network device;
(c) applying one or more test files to each configuration file of the device; and
(d) generating a security assessment report for the network device.

79. A method for diagnosing compliance of a security policy of a communications network, said method comprising the steps of:
(a) accessing configuration files of substantially all network devices in the communications network;
(b) extracting communications network connectivity information from the configuration files;
(c) manipulating connectivity information by employing at least one of network algorithms, modeling and parsing techniques; and
(d) generating a security assessment report on the communications network.
